(19) United States
(12) Patent Application Publication
(10) Pub. No.: US 2026/0204697 A1
(43) Pub. Date: Jul. 16, 2026

(54) SOLID-STATE BATTERY AND METHOD OF MANUFACTURING SOLID-STATE BATTERY

(71) Applicant: HONDA MOTOR CO., LTD., Tokyo (JP)

(72) Inventors: Kizashi IWAKIRI, Saitama (JP); Masahiro HOKAZONO, Saitama (JP); Fumikazu NAKAZAWA, Saitama (JP)

(21) Appl. No.: 19/444,198

(22) Filed: Jan. 9, 2026

(30) Foreign Application Priority Data
Jan. 14, 2025 (JP) 2025-004595

(51) Int. Cl. H01M 50/124; H01M 10/0585; H01M 50/121

(52) U.S. Cl. CPC H01M 50/1243; H01M 10/0585; H01M 50/121

(57) ABSTRACT

The solid-state battery includes a stacked body, the stacked body including a plurality of positive electrode layers, solid electrolyte layers, and negative electrode layers which are stacked. Insulating materials are arranged at ends of the positive electrode layers orthogonal to a stacking direction, ends of the insulating materials are located outward of ends of the negative electrode layers in a first direction orthogonal to the stacking direction, the stacked body includes a second insulating material that covers a part of ends of the insulating materials in the first direction, the second insulating material covers at least a part of each of the ends of all of the insulating materials, an end surface of the stacked body, on which the second insulating material is arranged, includes a first region that is a central portion in the stacking direction and second regions that are opposite end portions in the stacking direction.

This application is based on and claims the benefit of priority from Japanese Patent Application No. 2025-004595, filed on 14 January 2025, the content of which is incorporated herein by reference.

### BACKGROUND OF THE INVENTION

### Field of the Invention

The present invention relates to a solid-state battery and a method of manufacturing a solid-state battery.

### Related Art

In recent years, research and development has been conducted on secondary batteries that contribute to energy efficiency in order to ensure many people have access to reliable, sustainable, and advanced energy at reasonable prices. As the secondary battery, a solid-state battery (solid-state secondary battery) including a solid electrolyte has been attracting attention.

The solid-state battery includes a stacked body in which a positive electrode layer, a solid electrolyte layer, and a negative electrode layer are stacked. In the stacked body, there may be a layer that extends further outward than other layers. A technique is known in which side surfaces of such a stacked body are protected with a coating layer made of resin or the like (for example, see Japanese Unexamined Patent Application, Publication No. 2019-121532).

Patent Document 1: Japanese Unexamined Patent Application, Publication No. 2019-121532

### SUMMARY OF THE INVENTION

An all-solid-state battery disclosed in Japanese Unexamined Patent Application, Publication No. 2019-121532 includes a resin layer that covers at least side surfaces of a stacked body of the all-solid-state battery. However, in a case where a resin coating is provided on the entirety of the side surfaces of the stacked body, stress may be concentrated particularly on electrode layers located at opposite ends in a stacking direction of an electrode stacked body due to expansion and contraction of a negative electrode caused by charging and discharging of the solid-state battery. On the other hand, during manufacturing the solid-state battery, there is a possibility that stacking misalignment may occur, for example, when the stacked body is conveyed and housed in an exterior body, and therefore it is necessary to prevent the stacking misalignment of the stacked body.

The present invention has been made in view of the above circumstance, and has an object to provide a solid-state battery that can prevent stacking misalignment of a stacked body and to reduce stress concentration due to expansion and contraction of electrodes.

(1) The present invention is related to a solid-state battery including a stacked body, the stacked body including a plurality of positive electrode layers, solid electrolyte layers, and negative electrode layers which are stacked. In the solid-state battery, insulating materials are arranged at ends of the positive electrode layers, the ends being orthogonal to a stacking direction, ends of the insulating materials are located outward of ends of the negative electrode layers in a first direction orthogonal to the stacking direction, the stacked body includes a second insulating material that covers a part of ends of the insulating materials in the first direction, the second insulating material covers at least a part of each of the ends of all of the insulating materials, an end surface of the stacked body, on which the second insulating material is arranged, includes a first region that is a central portion in the stacking direction and second regions that are opposite end portions in the stacking direction, and in a case where a total length of the stacked body in a second direction orthogonal to the stacking direction and the first direction is defined as 100%, the second insulating material is arranged in a region having a length of 90% or more in the first region.

(2) In the solid-state battery according to (1), the second insulating material is arranged on one end surface of the stacked body such that some points the second insulating material are connected to each other.

(3) In the solid-state battery according to (1) or (2), in a case where a total length in the stacking direction of the stacked body is defined as 100%, a length in the stacking direction of the first region is 1% or more and 98% or less, in the case where the total length in the stacking direction of the stacked body is defined as 100%, a length in the stacking direction of the second region is 1% or more and 98% or less, and the second insulating material is formed in one or more strip shapes in the second region.

(4) In the solid-state battery according to any one of (1) to (3), the second insulating material is arranged in an area of 50% by area or more and 100% by area or less relative to an area of the first region, and is arranged in an area of 51% by area or more and 99% by area or less relative to an area of the second region.

(5) The present invention is also related to a method of manufacturing the solid-state battery according to any one of (1) to (4), the method including: a stacking process of stacking the positive electrode layers, the solid electrolyte layers, and the negative electrode layers to obtain the stacked body; and a coating process of forming the second insulating material on an end surface in the first direction of the stacked body, the coating process including a process of arranging a coating agent on a central portion of the end surface in the first direction of the stacked body, and a process of spreading the coating agent.

With the present invention, it is possible to provide a solid-state battery that can prevent stacking misalignment of a stacked body and to reduce stress concentration due to expansion and contraction of electrodes.

### BRIEF DESCRIPTION OF THE DRAWINGS

FIG. 1 is a view illustrating a solid-state battery according to a first embodiment when viewed from a side (in a first direction);

FIG. 2 is a view illustrating the solid-state battery according to the first embodiment when viewed from a side (in a second direction);

FIG. 3 is a view illustrating a solid-state battery according to a second embodiment when viewed from a side (in a first direction);

FIG. 4 is a view illustrating a solid-state battery according to a third embodiment when viewed from a side (in a first direction);

FIG. 5 is a view illustrating a solid-state battery according to another example when viewed from a side (in a first direction);

FIG. 6 is a view illustrating a solid-state battery according to another example when viewed from a side (in a first direction); and

FIG. 7 is a schematic view illustrating a process of a method of manufacturing the solid-state battery according to the present embodiments when viewed from a side (in a second direction).

### DETAILED DESCRIPTION OF THE INVENTION

### First Embodiment

### Solid-State Battery

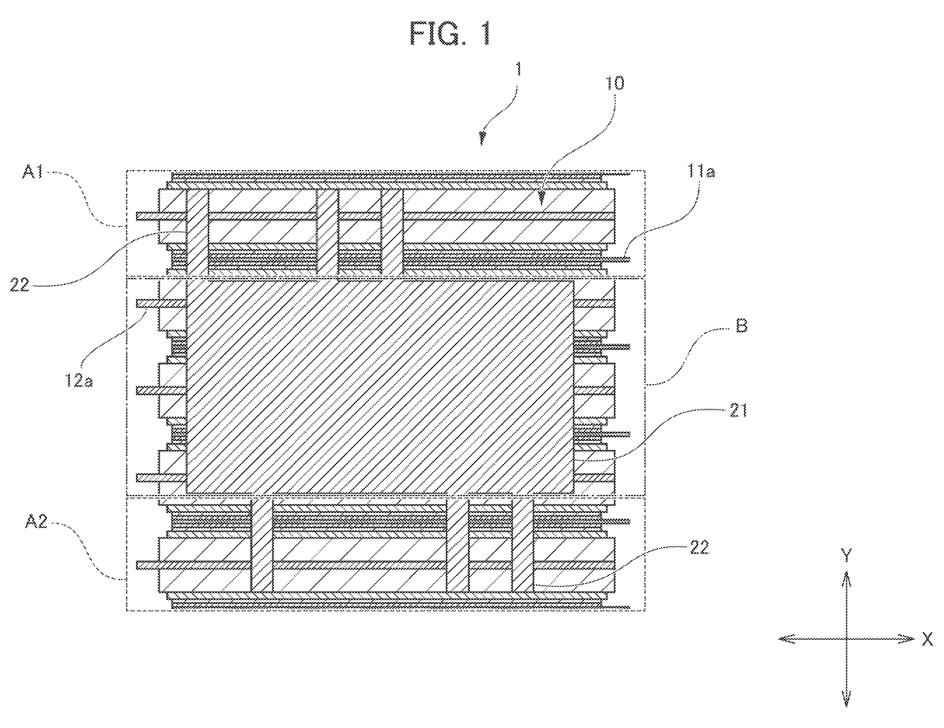

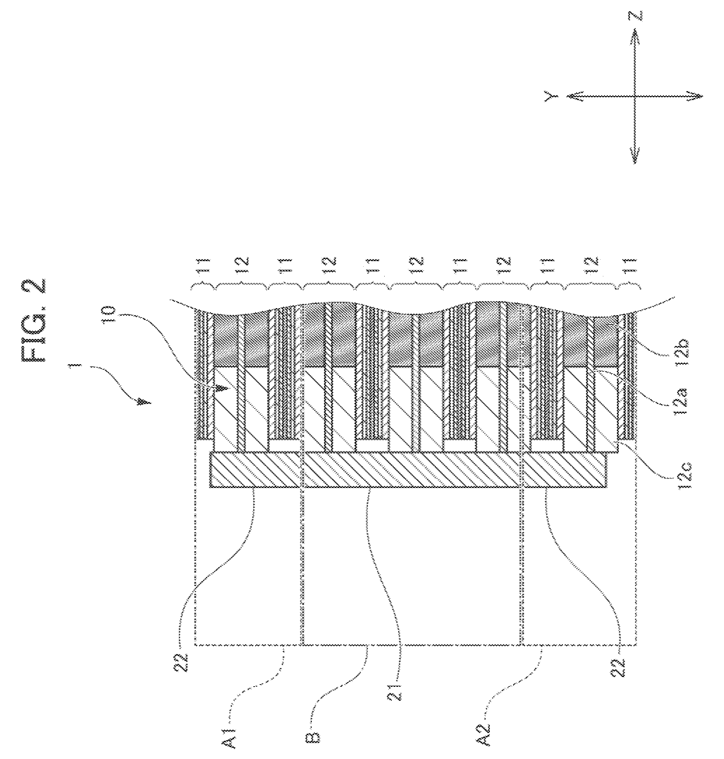

A solid-state battery 1 according to the present embodiment includes a stacked body 10 in which a plurality of positive electrode layers, solid electrolyte layers, and negative electrode layers are stacked, as illustrated in FIGS. 1 and 2. An example of the solid-state battery may include a lithium metal secondary battery with a lithium metal as a negative electrode active material, or a lithium ion secondary battery.

### Stacked Body

The stacked body 10 has a stacked structure in which a positive electrode layer, a solid electrolyte layer, and a negative electrode layer are stacked in this order. In FIG. 2, the stacked body 10 has a structure in which stacked structures 11 and 12 are repeatedly stacked. The stacked structure 11 includes a negative electrode layer and a solid electrolyte layer, and the stacked structure 12 includes a positive electrode layer. The positive electrode layer includes a positive electrode current collector and a positive electrode active material layer. The negative electrode layer includes a negative electrode current collector and a negative electrode active material layer. The stacked body 10 may also include an intermediate layer arranged between the electrolyte layer and the negative electrode layer, for example, in addition to the above. In the stacked body 10, a stacking direction of each layer is a Y direction in each of the drawings.

A positive electrode current collector 12a is arranged in contact with a positive electrode active material layer 12b, and has a function of performing current collection of the positive electrode active material layer 12b. A material of the positive electrode current collector 12a is not particularly limited as long as being capable of performing the current collection of the positive electrode active material layer 12b. Examples of materials for the positive electrode current collector 12a may include aluminum, aluminum alloys, stainless steel, nickel, iron, and titanium, and is preferably at least one selected from the group consisting of aluminum, aluminum alloys, and stainless steel.

An example of the positive electrode current collector 12a may be a foil shape or a plate shape. A thickness of the positive electrode current collector 12a is not particularly limited, and may be the same that used in a positive electrode of a general solid-state battery. The thickness of the positive electrode current collector 12a may be for example, in a range of 0.1 μm or more and 1 mm or less.

The positive electrode current collector 12a has substantially a rectangular shape when viewed in the stacking direction, and any side thereof extends to be electrically connected to a positive electrode tab lead. In other words, an extending direction of the current collector (an X direction in FIG. 1) is a direction orthogonal to any one of the sides of the positive electrode current collector 12a having the rectangular shape.

The positive electrode active material layer 12b is a layer containing at least a positive electrode active material. The positive electrode active material contained in the positive electrode active material layer 12b is not particularly limited as long as it is usable in the positive electrode active material layer 12b of a general secondary battery. For example, in a case of a lithium ion battery, examples of the positive electrode active material include a layered active material containing lithium, a spinel type active material, and an olivine type active material. Specific examples of the positive electrode active materials include lithium cobalt oxide (LiCoO₂), lithium nickel oxide (LiNiO₂), LiNiₚMn_{q}CoᵣO₂ (p + q + r = 1), LiNiₚAl_{q}CoᵣO₂ (p + q + r = 1), lithium manganese oxide (LiMn₂O₄), a different element substituent Li-Mn spinel represented by Li₁ +xMn₂ -x-yM_{y}O₄ (x + y = 2, M being at least one selected from Al, Mg, Co, Fe, Ni, and Zn), lithium titanate (oxide containing Li and Ti), and lithium metal phosphate (LiMPO₄, M being at least one selected from Fe, Mn, Co, and Ni).

The positive electrode active material layer 12b may optionally contain a solid electrolyte, which will be described below, for the purpose of improving lithium ionic conductivity. In addition, the positive electrode active material layer 12b may optionally contain a binder, a conductive additive, and the like.

A thickness of the positive electrode active material layer 12b is not particularly limited and can be set appropriately depending on a desired performance of the battery. The thickness of the positive electrode layer may be, for example, in a range of 0.1 μm or more and 1 mm or less.

An insulating material 12c is provided at an end of the positive electrode layer orthogonal to the stacking direction. The insulating material 12c is arranged at the end of the positive electrode layer, and thus when being connected to tab leads of negative electrode current collector tabs extending from the negative electrode current collectors 11a in respective cell structures, it is possible to avoid contact between the negative electrode current collector tabs and positive electrode ends by bending of the negative electrode current collector tabs, and to prevent short circuits. Furthermore, it is possible to prevent an occurrence of cracks due to a change in volume that accompanies repetitive charging and discharging, and it is also possible to prevent a short circuit due to cracks.

A shape of the insulating material 12c is not limited as long as being provided at the end of the positive electrode layer. A size of the insulating material 12c is not particularly limited as long as being in contact with a part or the whole of the end surface of the positive electrode layer.

A material of the insulating material 12c is not particularly limited as long as exhibiting insulating properties, and may be a so-called insulator other than a semiconductor or a conductor. The material of the insulating material 12c can be appropriately selected depending on desired adding characteristics, and may be, for example, an insulating resin.

As illustrated in FIG. 2, an end of the insulating material 12c is arranged outward from ends of the negative electrode layer and the solid electrolyte layer in a direction orthogonal to the stacking direction (a first direction: Z direction illustrated in FIG. 2).

The solid electrolyte layer is arranged between the positive electrode layer and the negative electrode layer. The solid electrolyte layer contains a solid electrolyte. The solid electrolyte is not particularly limited as long as having ionic conductivity and insulating properties. Examples of the solid electrolyte include sulfide solid electrolyte materials, oxide solid electrolyte materials, halide solid electrolytes, inorganic solid electrolytes such as lithium-containing salts, polymer-based solid electrolytes such as polyethylene oxide, and gel-based solid electrolytes containing lithium-containing salts or lithium-ion conductive ionic liquids. Out of these materials, the sulfide solid electrolyte materials are preferred from the viewpoint of high conductivity characteristics of lithium ions, structural formability according to pressing, and favorable interfacial bonding properties. The solid electrolyte layer may optionally contain a binder.

The negative electrode current collector 11a is arranged in contact with the negative electrode active material layer, and has a function of performing current collection of the negative electrode active material layer. A material of the negative electrode current collector 11a is not particularly limited as long as being capable of performing current collection of the negative electrode active material layer, and example thereof include a metal containing at least one metal element selected from the group consisting of silver, palladium, gold, platinum, aluminum, copper, and nickel, an alloy such as stainless steel, or a non-metal such as carbon (C).

A shape of the negative electrode current collector 11a is not particularly limited, and examples thereof include a foil shape, a plate shape, a mesh shape, a nonwoven fabric shape, and a foaming shape. In addition, the negative electrode current collector 11a may include a carbon layer or the like arranged on its surface, or the surface may be roughened, in order to enhance adhesion to the negative electrode layer.

A thickness of the negative electrode current collector 11a is not particularly limited, and may be the same as that used in the negative electrode of a general secondary battery. The thickness of the negative electrode current collector 11a may be, for example, in a range of 0.1 μm or more and 1 mm or less.

The negative electrode active material layer is a layer containing a negative electrode active material that transfers lithium ions and electrons. The negative electrode active material contained in the negative electrode layer is not particularly limited as long as being used in the negative electrode layer of a general secondary battery. Examples of the negative electrode active materials include silicon-based active materials such as silicon and silicon alloys, a carbon-based active materials such as graphite and hard carbon, various oxide-based active materials such as lithium titanate, and lithium-based active materials such as metallic lithium and lithium alloys. The negative electrode active material may be one or a combination of two or more of the above materials

The negative electrode active material layer may optionally contain the above-described solid electrolyte for the purpose of improving ionic conductivity. The negative electrode layer may optionally contain a binder, a conductive additive, and the like. As these materials, materials generally used in the secondary battery can be used.

A thickness of the negative electrode layer is not particularly limited, and can be set appropriately depending on a desired performance of the battery. The thickness of the negative electrode layer may be, for example, in a range of 0.1 μm or more and 1 mm or less.

The solid-state battery 1 may include an intermediate layer. For example, when the solid-state battery 1 is a lithium metal battery having a lithium metal or a lithium alloy as the negative electrode active material, the intermediate layer can be arranged between the solid electrolyte layer and the negative electrode layer, as a layer having electronic conductivity and ionic conductivity.

### Second Insulating Material

Second insulating materials 21 and 22 are arranged on end portions of the stacked body 10 in a first direction orthogonal to the stacking direction (Y direction in each of the drawings). In order to easily form the second insulating materials 21 and 22, the first direction is preferably a direction (Z direction in each of the drawings) orthogonal to the stacking direction and orthogonal to the extending direction of the current collector (X direction in each of the drawings). The first direction may be the extending direction of the current collector. The second insulating materials 21 and 22 are arranged so as to cover the insulating material 12c at the end surface in the first direction of the stacked body 10, and has a function of protecting the end surface from which the insulating material 12c protrudes. Furthermore, when the stacked body 10 is conveyed during the manufacturing of the solid-state battery 1, stacking misalignment of the layers is prevented. FIGS. 1 and 2 illustrate a state in which the second insulating materials 21 and 22 are arranged on one end portion in the first direction, but is preferable that the second insulating materials 21 and 22 may also be arranged on the other end portion in the first direction.

The second insulating materials 21 and 22 are layers having insulating properties, and are made of a resin material, for example. As illustrated in FIG. 1, the second insulating materials 21 and 22 are layers that cover a part of the end surface in the first direction of the stacked body 10. The end surface in the first direction of the stacked body 10 is divided into a first region B and second regions A1 and A2. In this description, these regions are defined as regions where the second insulating materials 21 and 22 can be arranged, respectively. The second insulating material 21 is arranged in the first region B. The second insulating material 22 is arranged in the second regions A1 and A2. The first region B is a central portion in the stacking direction of the end surface. The second regions A1 and A2 are opposite end portions in the stacking direction of the end surface (upper and lower parts in FIG. 1).

In a case where a total length in the stacking direction of the stacked body 10 is defined as 100%, a length in the stacking direction of the first region B is preferably 1% or more and 98% or less, and may be 5% or more and 90% or less. In the case where the total length in the stacking direction of the stacked body 10 is defined as 100%, a length in the stacking direction of the second regions A1 and A2 is preferably 1% or more and 98% or less, and may be 5% or more and 90% or less.

The second insulating materials 21 and 22 cover at least a part of the ends of all the insulating materials 12c at one end surface. In addition, it is preferable that the second insulating materials 21 and 22 are connected to each other at least at some points and formed so as to be connected as a whole. Thus, the ends of all the insulating materials 12c are held by the second insulating materials 21 and 22, whereby it is possible to reliably prevent the stacking misalignment of the stacked body 10.

The second insulating material 21 is connected to the second insulating material 22, and is a layer formed in one or more strip shapes in the approximate stacking direction. Compared to a case where the second insulating material 21 is formed over the entire surfaces of the second regions A1 and A2, the second insulating material 21 having a strip shape is formed only in part of the second regions A1 and A2, whereby it is possible to prevent the solid electrolyte layer from cracking due to excessive stress concentration in the second regions A1 and A2 when the negative electrode expands and contracts during charging and discharging of the solid-state battery 1. The second insulating material 21 is a layer that is to mainly prevent the stacking misalignment of the stacked body 10 during the manufacturing of the solid-state battery 1. Accordingly, the second insulating material 21 is required to have a strength sufficient to prevent it from rupturing during the manufacturing, but the second insulating material 21 may rupture when the negative electrode expands and contracts during charging and discharging of the solid-state battery 1. The second insulating material 21 ruptures, and thus the stress concentration can be prevented more preferably.

In the present embodiment, the second insulating material 22 is a layer extending in a strip shape in the stacking direction. A width (length in the X direction) of the second insulating material 22 formed in a strip shape is preferably 0.1 times or more and 100 times or less, and more preferably 1 times or more and 50 times or less of the thickness (length in the stacking direction) of the positive electrode layer (stacked structure 12). In the present embodiment, three second insulating materials 22 are formed in each of the second regions A1 and A2. The number of second insulating materials 22 is not particularly limited.

It is preferable that the second insulating material 22 is arranged relatively uniformly from the viewpoint of preventing the stacking misalignment. For example, it is preferable that at least one is formed on each of left and right sides of the second regions A1 and A2 from the center of the one end surface of the stacked body 10.

The second insulating material 22 is preferably arranged so as to occupy an area of 5% by area or more and 99% by area or less of each of the second regions A1 and A2. This allows the electrode groups and the layers such as the solid electrolyte layer to be sufficiently fixed. In addition, the area is more preferably 5% by area or more and 50% by area or less. This preferably achieves the effect of fixing each layer while preventing an increase in weight and costs.

The second insulating material 21 is connected to the second insulating material 22, and thus is mainly to protect the end surface of the stacked body 10 by preventing the stacking misalignment of the stacked body 10 and relieving stress from the outside. The second insulating material 21 is preferably a continuous layer as a whole from the viewpoint of preventing the stacking misalignment, but may have voids or bubbles in some parts as long as the effect of the stress relief is sufficiently obtained. In the present embodiment, the second insulating material 21 is arranged in the central portion of the first region B, and covers the first region B from the upper end to the lower end of the stacked body 10 in the stacking direction. The second insulating material 21 covers the central portion of the stacked body 10 in the extending direction of the current collector, but does not cover opposite end portions. In other words, the second insulating material 21 completely covers the central portion and its vicinity of the first region B, and therefore can preferably relieve the stress from the outside.

In a case where the total length of the stacked body 10 in the second direction (X direction) orthogonal to the stacking direction (Y direction) and the first direction (Z direction) is defined as 100%, the second insulating material 21 is arranged in a region having a length of 90% or more of the first region B,. Moreover, the second insulating material 21 is preferably arranged at least in the central portion of the first region B in the direction (X direction in each of the drawings) orthogonal to the stacking direction. Thus, it is possible to uniformly disperse somewhat the stress from the outside. From the viewpoint of obtaining the above-described effect, it is preferable that the second insulating material 21 is arranged at a position distant at least 40% to the left and right from the center of the one end surface in a case where the length of the one end in the extending direction of the current collector (X direction in FIG. 1) is defined as 100%.

The second insulating material 21 is preferably arranged so as to occupy an area of 50% by area or more and 100% by area or less of the first region B. From the viewpoint of obtaining the above-described effect, the area is more preferably 51% by area or more and 75% by area or less.

The thickness of the second insulating materials 21 and 22 is not particularly limited, but is preferably 50 μm or more and 20 mm or less.

FIG. 2 illustrates in which the second insulating materials 21 and 22 are provided to be in contact with the end in the first direction of the insulating material 12c, and not to enter spaces adjacent to ends and stacking surfaces of other electrode layers (for example, negative electrode layers) located inward from the end described above. However, the second insulating materials 21 and 22 may enter the spaces.

The second insulating materials 21 and 22 are formed, for example, by coating a resin composition and then curing it. As such a resin composition, for example, a UV-curable resin composition, a heat-curable resin composition, or the like can be appropriately selected.

The stacked body 10 and the second insulating materials 21 and 22 are housed in an exterior body. The exterior body is made of a laminate film, for example. The laminate film is a film including a metal layer and a resin layer, and encloses the stacked body 10 and the second insulating materials 21 and 22 with one film or a plurality of films. The laminate film, with the stacked body 10 and the second insulating materials 21 and 22 enclosed therein, is brought into contact with and welded at some of its surfaces to form a sealing portion. The sealing portion is arranged approximately at the center of the stacked body 10 in the stacking direction, for example.

The solid-state battery 1 may have a configuration other than that described above, and may include, for example, a tab lead to which the current collector is electrically connected. Furthermore, a plurality of solid-state batteries 1 may be modularized to form a solid-state battery module. In this case, a surface pressure may be applied to the stacked body 10 through a buffer material by a restraint member such as a bind bar. In addition, a cooling device may be provided to cool the solid-state battery 1.

### Method of Manufacturing Solid-State Battery

A method of manufacturing a solid-state battery according to the present embodiment includes a stacking process of stacking a positive electrode layer, a solid electrolyte layer, and a negative electrode layer to obtain the stacked body 10, and a coating process of forming a second insulating material on an end surface in the first direction of the stacked body 10.

The stacking process includes a process of forming an electrode layer and an electrolyte layer. The process of forming the electrode layer and the electrolyte layer is not particularly limited, and may be performed by a known process. An example of the method of forming the electrode layer may include a method in which slurry containing an electrode active material is applied onto a current collector and then dried. An example of the method of forming the electrolyte layer may include a method in which slurry containing a solid electrolyte is applied onto a substrate and then dried. The electrode layers and the electrolyte layers obtained as described above are stacked, and an insulating material is formed on a periphery of a positive electrode current collector, whereby the stacked body 10 is obtained. The stacking process may include a process of pressing and integrating the stacked body 10.

The coating process is a process of forming second insulating materials 21 and 22 on end portions in the first direction of the stacked body 10 obtained by the stacking process. In the coating process, first, the stacked body 10 is arranged such that the first direction of a side, on which the second insulating materials 21 and 22 are formed, is a vertical direction. Next, a known coating device such as a dispenser is filled with a coating agent (resin composition) used to form the second insulating material, and the coating agent is applied from the coating device to the end portion in the first direction of the stacked body 10.

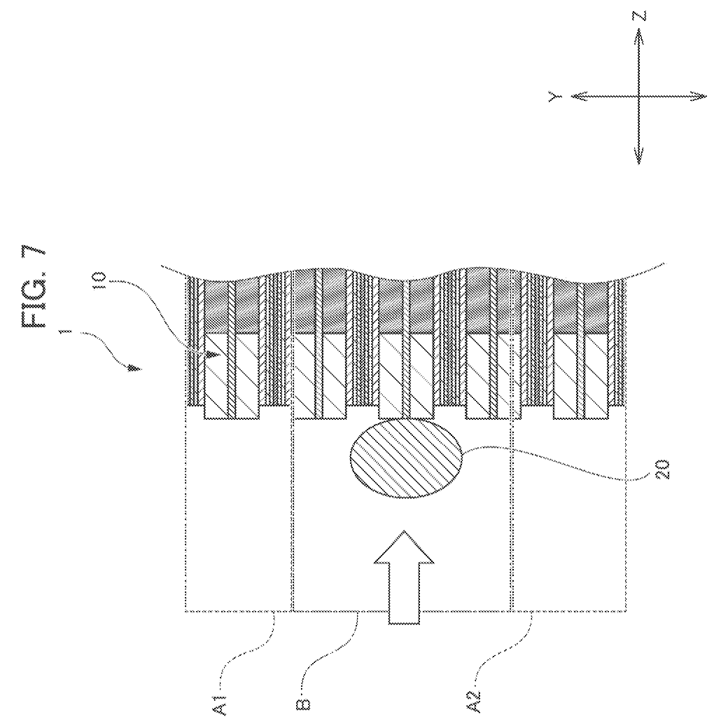

As illustrated in FIG. 7, the coating process preferably includes a process of arranging a coating agent 20 for forming the second insulating material 21 on the central portion of the end surface (first region B) by discharging the coating agent 20 from the coating device, and a process of spreading the arranged coating agent 20 along the end surface. As described above, the second insulating material 21 only needs to cover the area having a length of 90% or more in a second direction of the first region B when the total length of the stacked body 10 is defined as 100%, and does not necessarily need to cover the first region B as a whole. Accordingly, the coating process can be simplified by the above-described process. A specific method of spreading the coating agent 20 is not particularly limited, and the coating agent 20 may be spread (stretched and expanded) by applying a force in a direction of an arrow illustrated in FIG. 7 or the coating agent 20 may be left to spread naturally.

The coating process includes a process of forming the second insulating material 22 before and after the process of forming the second insulating material 21. The process of forming the second insulating material 22 is not particularly limited, and an example thereof includes a process of using the coating device for applying the coating agent 20 at a predetermined width to apply the second insulating material 22 having a strip shape while moving the coating device or the stacked body 10. At this time, the second insulating material 22 is formed so as to cover at least a part of the ends of all of the insulating materials 12c and to be connected to the second insulating material 21.

Next, solid-state batteries according to other embodiments of the present invention will be described. Hereinafter, the same components as those in the first embodiment will be denoted by the same reference numerals in the drawings, and will not be described.

### Second Embodiment

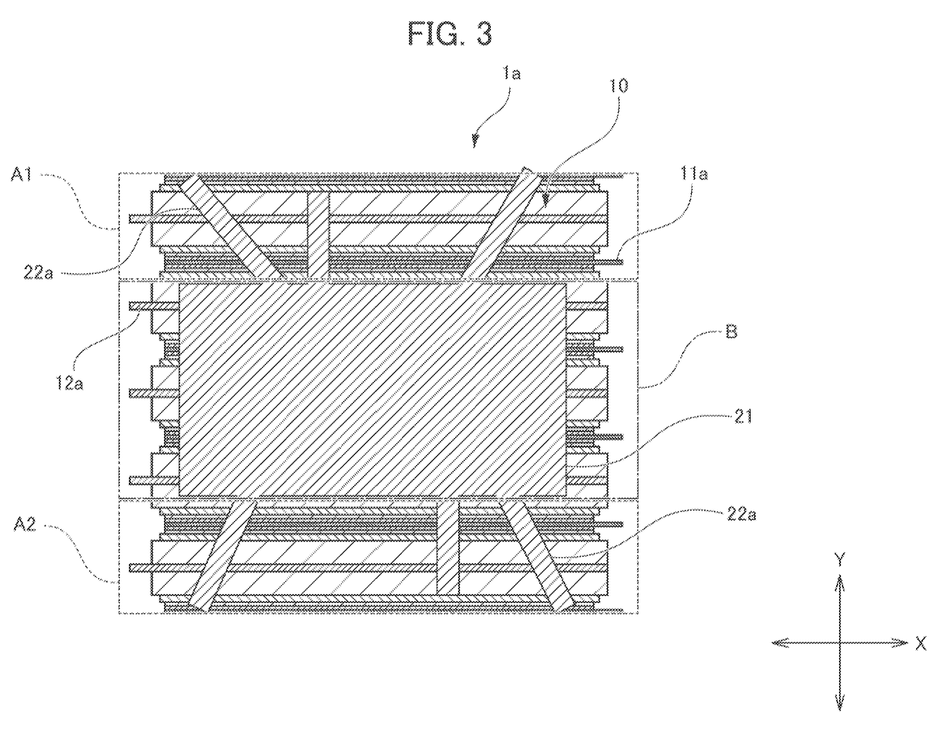

A solid-state battery 1a according to the present embodiment includes a second insulating material 22a as illustrated in FIG. 3. Other components of the solid-state battery 1a except for the above-described component are the same as those of the solid-state battery 1. In the present embodiment, the second insulating material 22a is partially oblique with respect to the stacking direction. This makes it possible to more preferably prevent the stacking misalignment in the extending direction of the current collector (X direction in FIG. 3) while obtaining the same effects as in the first embodiment.

### Third Embodiment

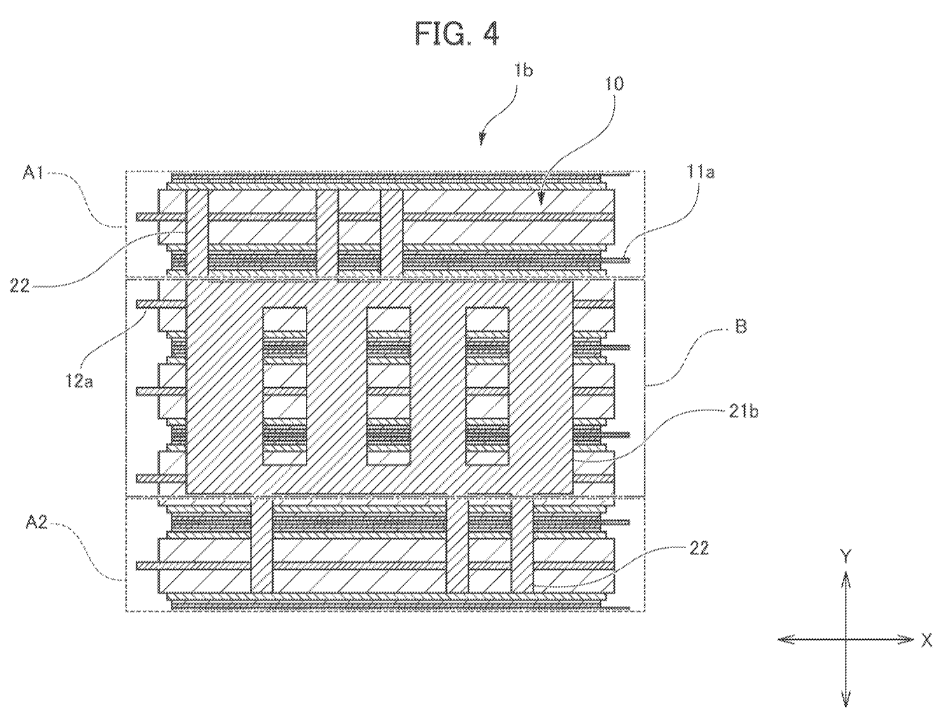

A solid-state battery 1b according to the present embodiment includes a second insulating material 21b as illustrated in FIG. 4. Other components of the solid-state battery 1b except for the above-described component are the same as those of the solid-state battery 1. In the present embodiment, the second insulating material 21b includes a partial void. This reduces the Young's modulus of the second insulating material 21b in the stacking direction. Accordingly, the above configuration makes it possible for the second insulating material 21b to more easily follow the expansion and contraction of the negative electrode during charging and discharging of the solid-state battery 1b, thereby further preventing cracking of the solid electrolyte layer while obtaining the same effects as in the first embodiment.

### Other Examples

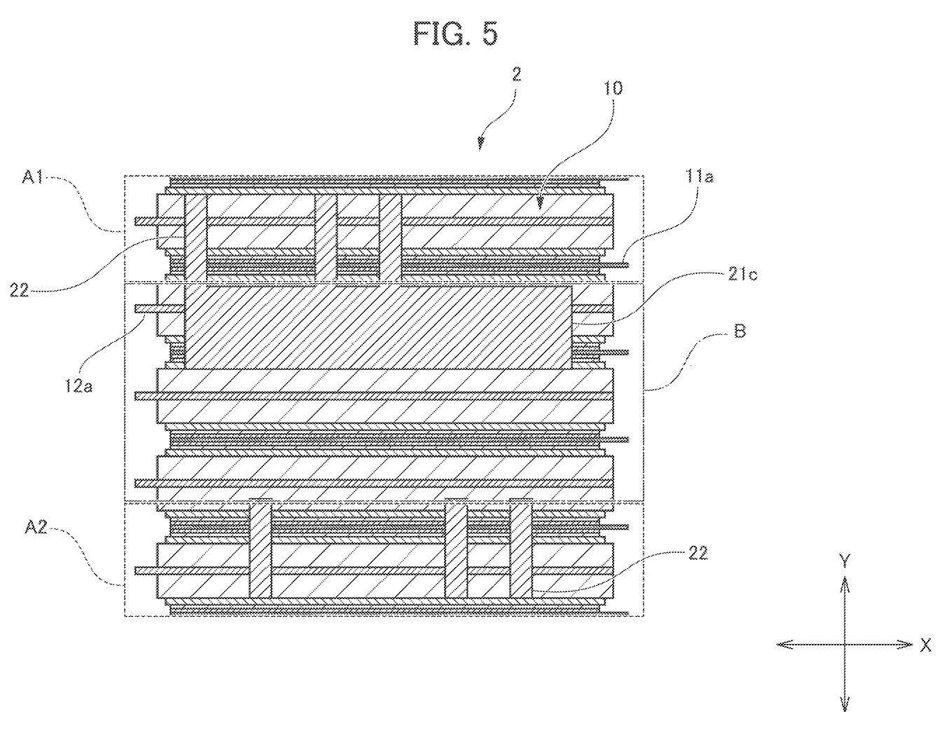

FIG. 5 is a view illustrating a solid-state battery 2 according to another example. The solid-state battery 2 includes a second insulating material 21c as illustrated in FIG. 5. Other components of the solid-state battery 2 except for the above-described component are the same as those of the solid-state battery 1. The second insulating material 21c is not connected to the second insulating materials 22 formed in the second region A2. Some of the insulating materials 12c are not covered with the second insulating materials 21c and 22. In this example, the stacking misalignment of some of the insulating materials 12c not fixed may be caused when the stacked body 10 is conveyed.

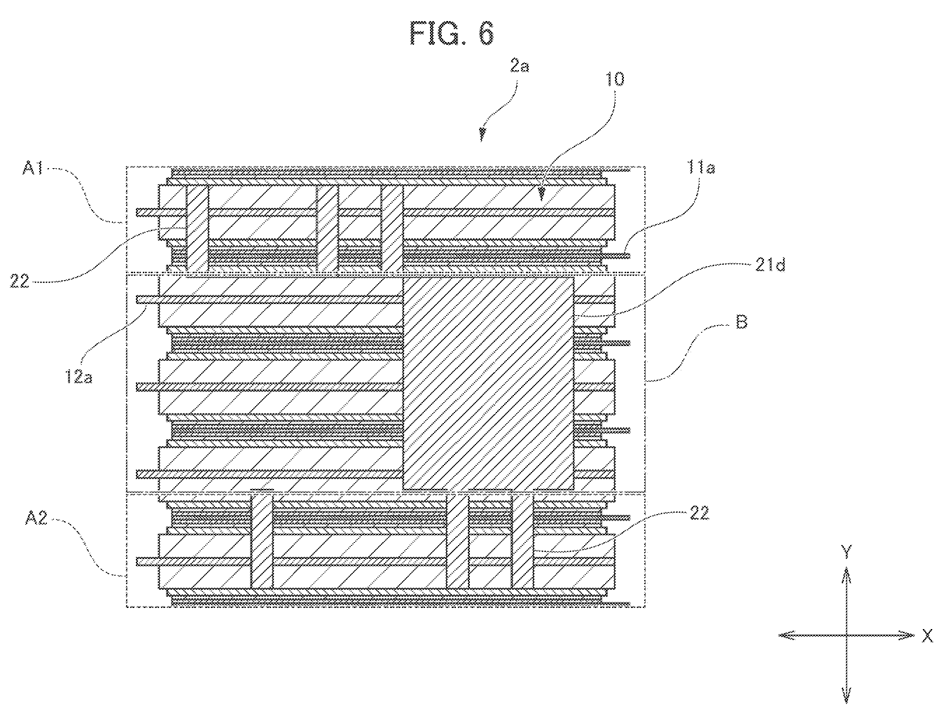

FIG. 6 is a view illustrating a solid-state battery 2a according to another example. The solid-state battery 2a includes a second insulating material 21d as illustrated in FIG. 6. Other components of the solid-state battery 2a except for the above-described component are the same as those of the solid-state battery 1. The second insulating material 21d is not connected to the second insulating materials 22 formed in parts of the second regions A1 and A2. In addition, the second insulating material 21d is located to be biased to the right side of the first region B. In such a case, the stacking misalignment of some of the insulating materials 12c may be caused, and the stress applied to the end surface of the stacked body 10 may be uneven, which may result in insufficient protection of the end surface of the stacked body 10.

### EXPLANATION OF REFERENCE NUMERALS

1, 1a, 1b, solid-state battery

10 stacked body

11 stacked structure

12 stacked structure (including a positive electrode layer)

12a positive electrode current collector

12b positive electrode active material layer

12c insulating material

20 coating agent

21, 21b, 21c, 22, 22a second insulating material

A1, A2 second regions

B first region

X second direction

Y stacking direction

Z first direction

What is claimed is:

1. A solid-state battery comprising:
a stacked body, the stacked body including a plurality of positive electrode layers, solid electrolyte layers, and negative electrode layers which are stacked, wherein
insulating materials are arranged at ends of the positive electrode layers, the ends being orthogonal to a stacking direction,
ends of the insulating materials are located outward of ends of the negative electrode layers in a first direction orthogonal to the stacking direction,
the stacked body includes a second insulating material that covers a part of ends of the insulating materials in the first direction,
the second insulating material covers at least a part of each of the ends of all of the insulating materials,
an end surface of the stacked body, on which the second insulating material is arranged, includes a first region that is a central portion in the stacking direction and second regions that are opposite end portions in the stacking direction, and
in a case where a total length of the stacked body in a second direction orthogonal to the stacking direction and the first direction is defined as 100%, the second insulating material is arranged in a region having a length of 90% or more in the first region.

2. The solid-state battery according to claim 1, wherein
the second insulating material is arranged on one end surface of the stacked body such that some points of the second insulating material are connected to each other.

3. The solid-state battery according to claim 1, wherein
in a case where a total length in the stacking direction of the stacked body is defined as 100%, a length in the stacking direction of the first region is 1% or more and 98% or less,
in the case where the total length in the stacking direction of the stacked body is defined as 100%, a length in the stacking direction of the second region is 1% or more and 98% or less, and
the second insulating material is formed in one or more strip shapes in the second region.

4. The solid-state battery according to claim 2, wherein
in a case where a total length in the stacking direction of the stacked body is defined as 100%, a length in the stacking direction of the first region is 1% or more and 98% or less,
in the case where the total length in the stacking direction of the stacked body is defined as 100%, a length in the stacking direction of the second region is 1% or more and 98% or less, and
the second insulating material is formed in one or more strip shapes in the second region.

5. The solid-state battery according to claim 1, wherein
the second insulating material is arranged in an area of 50% by area or more and 100% by area or less relative to an area of the first region, and is arranged in an area of 51% by area or more and 99% by area or less relative to an area of the second region.

6. The solid-state battery according to claim 2, wherein
the second insulating material is arranged in an area of 50% by area or more and 100% by area or less relative to an area of the first region, and is arranged in an area of 51% by area or more and 99% by area or less relative to an area of the second region.

7. A method of manufacturing the solid-state battery according to claim 1, the method comprising:
a stacking process of stacking the positive electrode layers, the solid electrolyte layers, and the negative electrode layers to obtain the stacked body; and
a coating process of forming the second insulating material on an end surface in the first direction of the stacked body,
the coating process including a process of arranging a coating agent on a central portion of the end surface in the first direction of the stacked body, and a process of spreading the coating agent.
